(19) United States
(12) Patent Application Publication
(10) Pub. No.: US 2024/0255472 A1
(43) Pub. Date: Aug. 1, 2024

(54) ACTUATION SYNCHRONIZATION MECHANISM FOR ACOUSTIC SIGNAL BASED MEASUREMENTS OF BATTERIES

(71) Applicant: Liminal Insights, Inc., Emeryville, CA (US)

(72) Inventors: Yu-Shi FONG, Emeryville, CA (US); Dennis YU, Alameda, CA (US); Shaurjo BISWAS, El Cerrito, CA (US); Andrew G. HSIEH, Emeryville, CA (US)

(73) Assignee: Liminal Insights, Inc., Emeryville, CA (US)

(21) Appl. No.: 18/424,453

(22) Filed: Jan. 26, 2024

Related U.S. Application Data
(60) Provisional application No. 63/481,852, filed on Jan. 27, 2023.

(51) Int. Cl. G01N 29/28; G01N 29/04; G01N 29/22; H01M 10/42

(52) U.S. Cl. CPC G01N 29/28; G01N 29/043; G01N 29/223; H01M 10/4285; G01N 2291/0289; G01N 2291/048; G01N 2291/106

(57) ABSTRACT

One or more aspects of the present disclosure are directed to a synchronized actuation system for holding samples (e.g., battery cells) in place such that ultrasonic sensors can make physical contacts with the samples to transmit and receive acoustic signals across the samples for purposes of making ultrasound measurements of the battery sample. The movement of sensors on both sides of a sample can be synchronized (as opposed to being handled via independent actuators) to improve signal repeatability.

### CROSS-REFERENCE TO RELATED APPLICATIONS

This application claims the benefit of priority to U.S. provisional application No. 63/481,852, filed on Jan. 27, 2023, entitled ACTUATION SYNCHRONIZATION MECHANISM FOR ACOUSTIC SIGNAL BASED MEASUREMENTS OF BATTERIES, which is expressly incorporated by reference herein in its entirety.

### FIELD OF DISCLOSURE

The present disclosure is directed to systems used for monitoring and inspection of batteries based on acoustic signals. More specifically, exemplary aspects are directed to a synchronized actuation mechanism with sample position feedback loop used in such systems.

### BACKGROUND

Demand for production of battery cells is on the rise owing to an increase in their use across various industries such as consumer electronics, automotive, clean energy, etc. Efficient and fast battery diagnostics methods are important for increasing quality, lifetime, and manufacturing process efficiency for batteries. In the case of manufacturing and production, reducing costs (e.g., price per kilowatt-hour (kWh)) is an important goal. Production costs and quality can be reduced by optimizing existing processes and/or introducing new technologies. For example, technological advances in the area of improved monitoring, manufacturing, and diagnostics can lead to cost efficiencies by shortening production process times (thus also reducing energy consumption during production), reducing waste due to damaged cells and cell parts, improving quality, etc.

### BRIEF DESCRIPTION OF THE DRAWINGS

The accompanying drawings are presented to aid in the description of various aspects of the disclosure and are provided solely for illustration and not limitation.

FIG. 1 illustrates an example system for analyzing a sample using acoustic signal-based analysis, according to some aspects of the present disclosure;

FIG. 2 illustrates another example system for analyzing a sample using acoustic signal-based analysis, according to some aspects of the present disclosure;

FIG. 3 illustrates an isometric view of an example holder with a synchronized actuation mechanism according to some aspects of the present disclosure.

FIG. 4 illustrates a front view of example holder of FIG. 3 according to some aspects of the present disclosure;

FIGS. 5A-B show two snapshots of a holder if FIG. 3 in open and closed positions respectively according to some aspects of the present disclosure;

FIG. 6 is a flowchart of a method of operating actuator of FIGS. 3 through 5A-B according to some aspects of the present disclosure; and

FIG. 7 illustrates an example computing device architecture of an example computing device, in accordance with some aspects of the disclosure.

### SUMMARY

The present disclosure provides a synchronized mechanical actuation system for a holder that is configured to hold samples (battery cells) in place such that ultrasonic sensors can make physical contacts with the samples to transmit and receive acoustic signals across the samples for purposes of making ultrasound measurements of the battery sample. The movement of sensors on both sides of a sample can be synchronized (as opposed to being handled via independent actuators) to improve signal repeatability.

In one aspect, a system for performing acoustic measurements on battery cells includes a plurality of transmitting sensors configured to transmit acoustic signals across a sample; a plurality of receiving sensors configured to receive response signals through the sample in response to the acoustic signals transmitted therethrough; and an actuator configured to synchronously actuate the plurality of transmitting sensors and the plurality of receiving sensors to provide same spacing and speed of motion between the plurality of transmitting sensors and the plurality of receiving sensors relative to the sample.

In another aspect, the system further includes at least one sensor configured to determine a placement of the sample relative to two plates in between which the sample is positioned for performing the acoustic measurements.

In another aspect, the actuator is configured to adjust the speed of motion based on feedback received from the at least one sensor.

In another aspect, the actuator is configured to synchronously actuate the plurality of transmitting sensors and the plurality of receiving sensors when the at least one sensor indicates the placement of the sample to be correct relative to the two plates.

In another aspect, the placement of the sample relative to the two plates is correct when the sample is at an equidistance from the two plates.

In another aspect, the system further includes a first side structure mechanically attached to the actuator and configured to control movement of the plurality of transmitting sensors; and a second side structure mechanically attached to the actuator and configured to control movement of the plurality of receiving sensors.

In another aspect, the system further includes a holder mechanically coupled to the actuator, the holder configured to hold in place the actuator for acoustic measurement of batteries.

In another aspect, the sample is a pouch battery cell.

In another aspect, the sample is a cylindrical battery cell.

In another aspect, the sample is a prismatic battery cell.

In one aspect, a system includes a controller having one or more memories having computer-readable instructions stored therein, and one or more processors configured to execute the computer-readable instructions to determine a location of a sample relative to a holder mechanism, wherein the holder mechanism is configured to hold the sample to be acoustically measured using a plurality of transmitting sensors and a plurality of receiving sensors; and generate one or more commands for actuating synchronous movement of the plurality of transmitting sensors and the plurality of receiving sensors such that the plurality of transmitting sensors and the plurality of receiving sensors come into contact with the sample at the same time for acoustic measurement of the sample.

In another aspect, the system further includes an actuator configured to receive the one or more commands for actuating the synchronous movement of the plurality of transmitting sensors and the plurality of receiving sensors.

In another aspect, the system further includes one or more sensors configured to collect data on a position of the sample relative to one or more plates that are configured to hold the sample in place to be acoustically measured.

In another aspect, the controller is configured to determine the location based on the data collected by the one or more sensors.

In another aspect, the controller is configured to adjust a position of the sample based on the data collected by the one or more sensors such that the sample is at an equidistance relative to two plates configured to hold the sample to be acoustically measured using the plurality of transmitting sensors and the plurality of receiving sensors.

In another aspect, the actuator is configured to adjust a speed of motion of the plurality of transmitting sensors and the plurality of receiving sensors based at least in part on the data collected by the one or more sensors.

In another aspect, the system further includes a first side structure mechanically attached to the actuator and configured to control movement of the plurality of transmitting sensors; and a second side structure mechanically attached to the actuator and configured to control movement of the plurality of receiving sensors.

In another aspect, the sample is a pouch battery cell.

In another aspect, the sample is a cylindrical battery cell.

In another aspect, the sample is a prismatic battery cell.

### DETAILED DESCRIPTION

Various examples of the disclosure are discussed in detail below. While specific implementations are discussed, it should be understood that this is done for illustration purposes. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an example in the present disclosure can be references to the same example or any example; and such references mean at least one of the examples.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

Demand for production of battery cells is on the rise owing to an increase in their use across various industries such as consumer electronics, automotive, clean energy, etc. Efficient and fast battery diagnostics methods are important for increasing quality, lifetime, and manufacturing process efficiency for batteries. In the case of manufacturing and production, reducing costs (e.g., price per kilowatt-hour (kWh)) is an important goal. Production costs and quality can be reduced by optimizing existing processes and/or introducing new technologies. For example, technological advances in the area of improved monitoring, manufacturing, and diagnostics can lead to cost efficiencies by shortening production process times (thus also reducing energy consumption during production), reducing waste due to damaged cells and cell parts, improving quality, etc.

Ultrasound inspection on batteries utilizes sensors on both sides of the sample, one for signal transmission and other to receive signals. Both sides can be moved to accommodate for batteries of different thickness, with different methods of conveyance in manufacturing line and benchtop applications. The ultrasonic sensors can make physical contact with a given battery cell under testing at sufficient force to take acoustic measurements. Equally, ultrasonic sensors also have to be able to move away from the battery cell after taking acoustic measurements to allow it to exit the measurement system. If movement on one side results in corresponding sensors on that side to reach the battery cell first, it may displace the battery or apply uneven loads, which results in unrepeatable measurements and inaccurate results.

Currently, a number of separate actuators, for each side of ultrasonic sensors, are configured to move the ultrasonic sensors to make contact with a battery cell to be acoustically tested/measured. These sensors, once in contact with the battery cell, can send and receive acoustic signals through a battery cell under testing. In one example, the actuators can be pneumatic. Compressibility of air increases potential instability, with each cycle, the compression and friction of air would change. This results in unsynchronized motion. The actuators are toggled manually to be synchronized. The manual adjustment methods are not accurate and the two sides are not well synchronized. The design requires the battery to be physically constrained to prevent displacement due to uneven loading by the sensors. There is no feedback from the system if the actuation is synchronized.

Aspects of the present disclosure provide an actuation mechanism that synchronizes sensor movement towards the battery on both sides of a holder. This synchronization can improve signal repeatability and address the limitations and flaws described above.

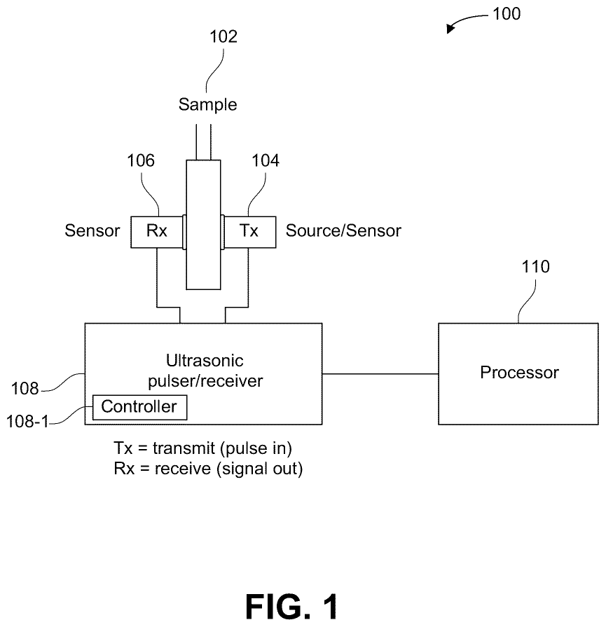

FIG. 1 illustrates an example system for analyzing a sample using acoustic signal-based analysis, according to some aspects of the present disclosure. System 100 may include sample 102. Sample 102 can include a battery cell or component thereof in any stage of production or manufacture of the battery cell or the individual components. In some examples, sample 102 can include a battery cell, electrolytes in various stages of wetting/distribution through a battery cell, one or more electrodes of the battery cell, thin films, separators, coated sheets, current collectors, electrode slurries, or materials for forming any of the above components during any stage of their formation. System 100 can include a transmitting transducer Tx 104 or other means for sending excitation sound signals into the battery cell (e.g., for transmitting a pulse or pulses of ultrasonic or other acoustic waves, vibrations, resonance measurements, etc., through the battery cell). System 100 can further include a receiving transducer Rx 106 or other means for receiving/sensing the sound signals, which can receive response signals generated from signals transmitted by Tx transducer 104. Any type of known or to be developed transducer for transmitting and receiving acoustic signals may be used as Tx transducer 104. Transmitted signals from Tx transducer 104, from one side of sample 102 on which Tx transducer 104 is located, may include input excitation signals. Reflected signals, e.g., from another side of sample 102, may include echo signals. It is understood that references to response signals may include both the input excitation signals and the echo signals. Further, Tx transducer 104 may also be configured to receive response signals, and similarly, Rx transducer 106 may also be configured to transmit acoustic signals. Any type of known or to be developed transducer for transmitting and receiving acoustic signals may be used as Rx transducer 106. Therefore, even though separately illustrated as Tx and Rx, the functionalities of these transducers may be for both sending and receiving acoustic signals. In various alternatives, even if not specifically illustrated, one or more Tx transducers and one or more Rx transducers can be placed on the same side or wall of sample 102, or on different (e.g., opposite) sides. Throughout this disclosure, reference may be made to a transducer pair (a transmitting transducer and a receiving transducer). Transducer Tx 104 and transducer Rx 106 may form a pair of transducers.

Acoustic pulser/receiver 108 can be coupled to Tx and Rx transducers 104, 106 for controlling the transmission of acoustic signals (e.g., ultrasound signals) and receiving response signals. Acoustic pulser/receiver 108 may include a controller 108-1 for adjusting the amplitude, frequency, and/or other signal features of the transmitted signals. Acoustic pulser/receiver 108 may also receive the signals from Rx transducers 106. In some examples, acoustic pulser/receiver 108 may be configured as a combined unit, while in some examples, an acoustic pulser for transmitting excitation signals through Tx transducer 104 can be a separate unit in communication with a receiver for receiving signals from Rx transducer 106. Processor 110 in communication with acoustic pulser/receiver 108 may be configured to store and analyze the response signal waveforms according to this disclosure. Although representatively shown as a single processor, processor 110 can include one or more processors, including remote processors, cloud computing infrastructure, etc.

Although not explicitly shown in FIG. 1, more than one Tx transducer and/or more than one Rx transducer can be placed in one or more spatial locations across sample 102. This allows studying a spatial variation of acoustic signal features across sample 102. A multiplexer can be configured in communication with the acoustic pulser/receiver 108 for separating and channeling the excitation signals to be transmitted and the response signals received. In some examples, various acoustic couplants can be used (e.g., solid, liquid, or combinations thereof) for making or enhancing contact between Tx and Rx transducers 104, 106 and sample 102. Furthermore, various attachment or fixturing mechanisms (e.g., pneumatic, compression, screws, etc.) can also be used for establishing or enhancing the contact between Tx and Rx transducers 104, 106 and sample 102.

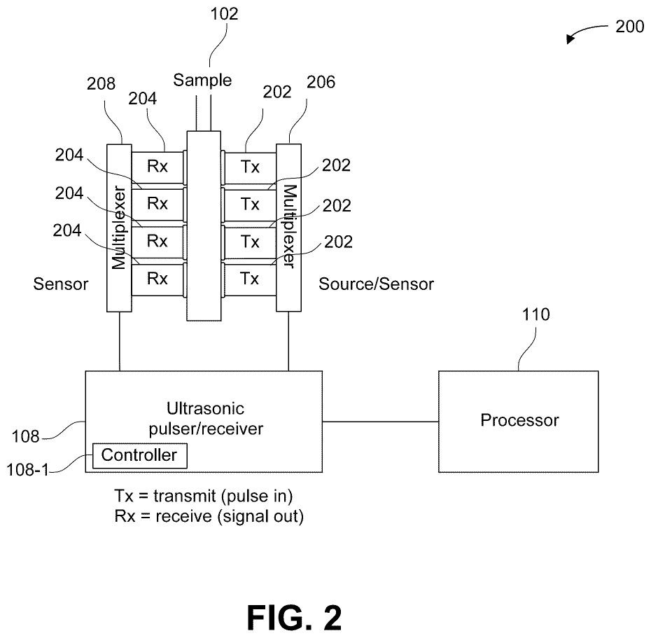

FIG. 2 illustrates another example system for analyzing a sample using acoustic signal-based analysis, according to some aspects of the present disclosure. In comparison with FIG. 1, system 200 of FIG. 2 illustrates a system in which multiple pairs of transmitting and receiving transducers are used for transmitting signals through a sample under testing (e.g., a battery cell) and performing acoustic signal-based analysis of the sample.

System 200 includes several transmitting Tx transducers 202 (each of which may be the same as Tx transducer 104 of FIG. 1). While an array of four examples Tx transducers 202 are shown in FIG. 2, the disclosure is not limited to four. Any number of transducers may be used (e.g., any number of Tx transducers ranging from 1 to 10, 15, 20, etc.).

Similarly, system 200 includes a number of receiving (sensing) Rx transducers 204 (each of which may be the same as Rx transducer 106 of FIG. 1). While an array of four examples Rx transducers 204 are shown in FIG. 2, the disclosure is not limited to four. Any number of transducers may be used (e.g., any number of Rx transducers ranging from 1 to 10, 15, 20, etc.). Any given Tx transducer 202 and Rx transducer 204 may form a transducer pair (FIG. 2 illustrates four transducer pairs). FIG. 2 also illustrates a multiplexer 206 coupled to the array of four Tx transducers 202 and a multiplexer 208 coupled to the array of four Rx transducers 204. As described above, each one of multiplexers 206 and 208 may be configured in communication with the acoustic pulser/receiver 108 for separating and channeling the excitation signals to be transmitted and the response signals received, respectively. In some examples, various acoustic couplants can be used (e.g., solid, liquid, or combinations thereof) for making or enhancing contact between Tx and Rx transducers 202, 204 and sample 102. Furthermore, various attachment or fixturing mechanisms (e.g., pneumatic, compression, screws, etc.) can also be used for establishing or enhancing the contact between Tx and Rx transducers 202, 204 and sample 102.

Spacing between Tx transducers 202 and Rx transducers 204 may be uniform and the same. System 200 also includes additional elements such as sample 102, ultrasonic pulser/receiver 108 (controller 108-1), processors 110, each of which may be the same as the corresponding counterpart described above with reference to FIG. 1 and hence will not be described further for sake of brevity.

As noted above, aspects of the present disclosure provide an actuation mechanism that synchronizes movement of sensors for acoustic measurement of a battery towards such battery on both sides. This synchronization can improve signal repeatability and address the limitations and flaws described above.

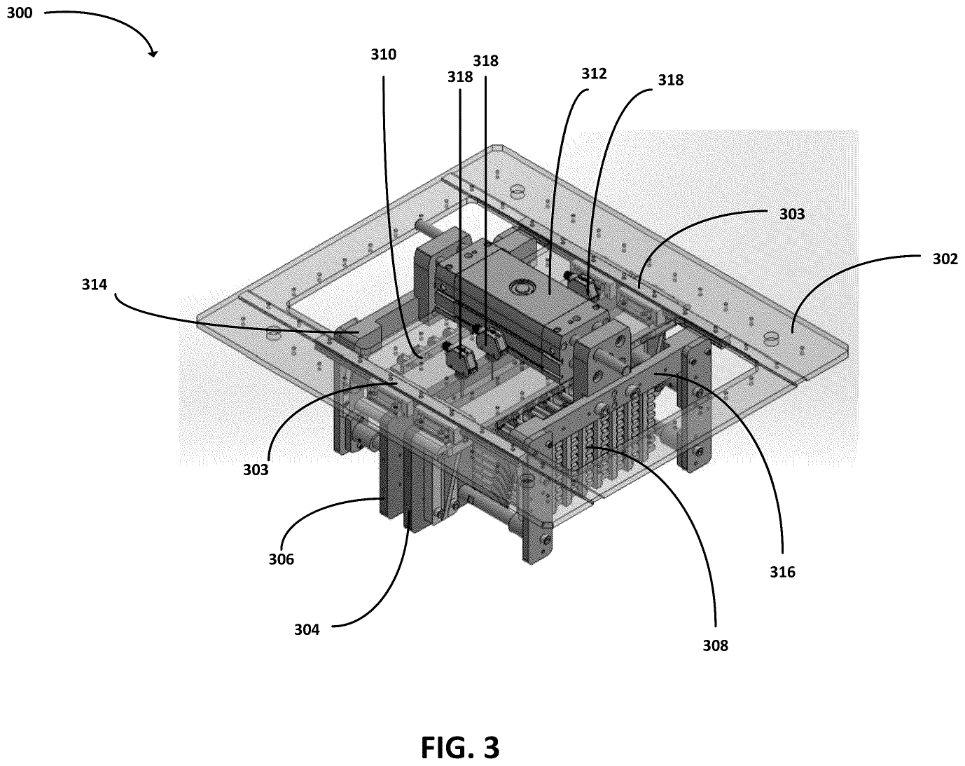

FIG. 3 illustrates an isometric view of an example holder with a synchronized actuation mechanism according to some aspects of the present disclosure.

Holder 300 may be used within example systems 100 and 200 of FIGS. 1 and 2 for holding sample 102 that can be acoustically measured using sensors 104/106 and/or sensors 202/204. As shown, holder 300 can be affixed to a fixture 302 (e.g., at the top via attachment mechanisms 303). Holder 300, fixture 302, and attachment mechanisms 303 may be made of any known or to be developed material suitable for enabling a synchronized actuation mechanism to operate as described herein. Plates 304 and 306 may be used for holding a sample (e.g., a battery cell) such as sample 102 in place for acoustic measurements. Plates 304 and 306 may be made of any known or to be developed material with sufficient durability (e.g., metal, plastic, etc.) for holding samples. Transmitting sensors 308 may be the same as sensors 202, while receiving sensors 310 (partially shown in FIG. 3) may be the same as sensors 204.

Actuation mechanism of holder 300 may include actuator 312 that is configured to synchronize movement of side structures 314 and 316 that can horizontally move sensors 308 and 310, respectively. Actuator 312 may be any known or to be developed actuator capable of providing synchronized movement of side structures 314 and 316 that can in turn move sensors 308 and 310 synchronously. Side structures 314 and 316 may be made of any known or to be developed suitable material (e.g., metal, plastic, etc.) Sensors 318 may be used to monitor position of a sample being tested and provide a feedback loop to actuator 312 for purposes of timing the movement of side structures 314 and 316 in order to bring sensors 308 and 310 into contact with the sample at the right time and with the same force for testing. The sample may also sit on an automated adjustment stage (not shown) that would move the sample to sit precisely in the centerline of structures 314 and 316. This aspect will be further described below.

In one example, actuator 312 may be communicatively coupled to processor 110, which can, based on various factors (e.g., feedback data received from sensors 318), determine generation and transmission of commands to actuator 312 to enable actuation thereof and ultimately synchronized movement of sensors 308 and 310 for acoustic measurement of a sample placed therebetween.

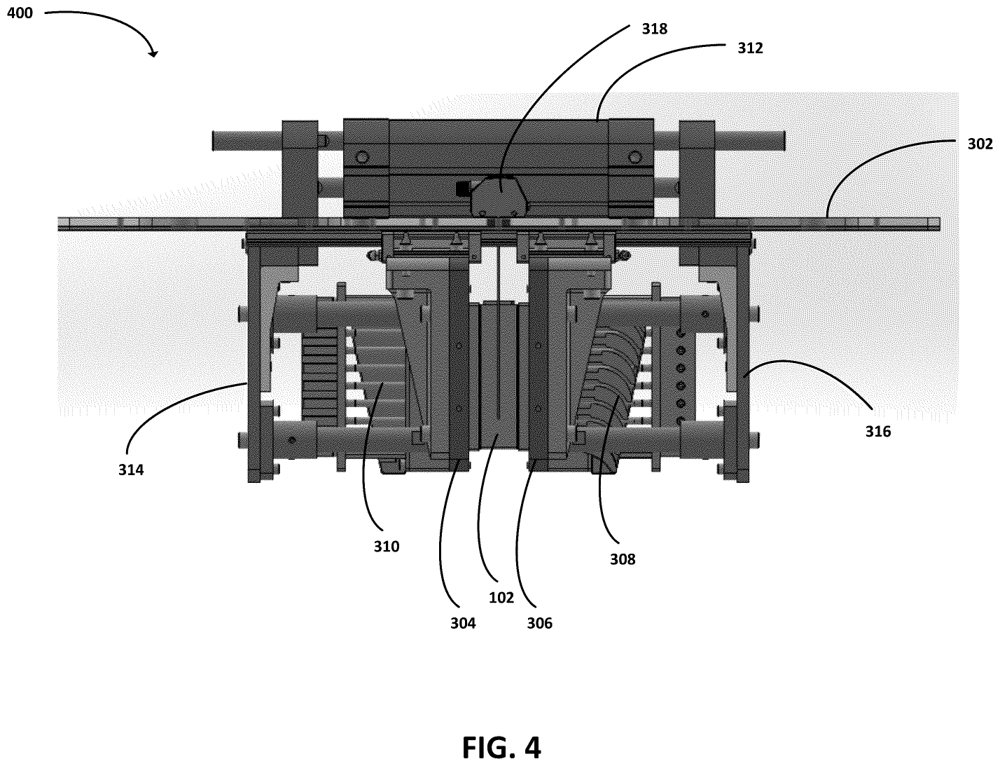

FIG. 4 illustrates a front view of example holder of FIG. 3 according to some aspects of the present disclosure.

Holder 400 is a front view of the holder 300 of FIG. 3 with a sample 102 shown inserted between plates 304 and 306 for acoustic measurement. Through synchronized movement of sensors 308 and 310 via actuator 312, sensors 304 and 306 are brought into contact with sample 102 using a uniform force provided by actuator 312 and transferred to sensors 308 and 310 via side structures 314 and 316. This uniform force hence provides uniform and synchronized motion of sensors 308 and 310, thus ensuring signal repeatability as samples such as sample 102 are placed between plates 304 and 306 and are acoustically measured.

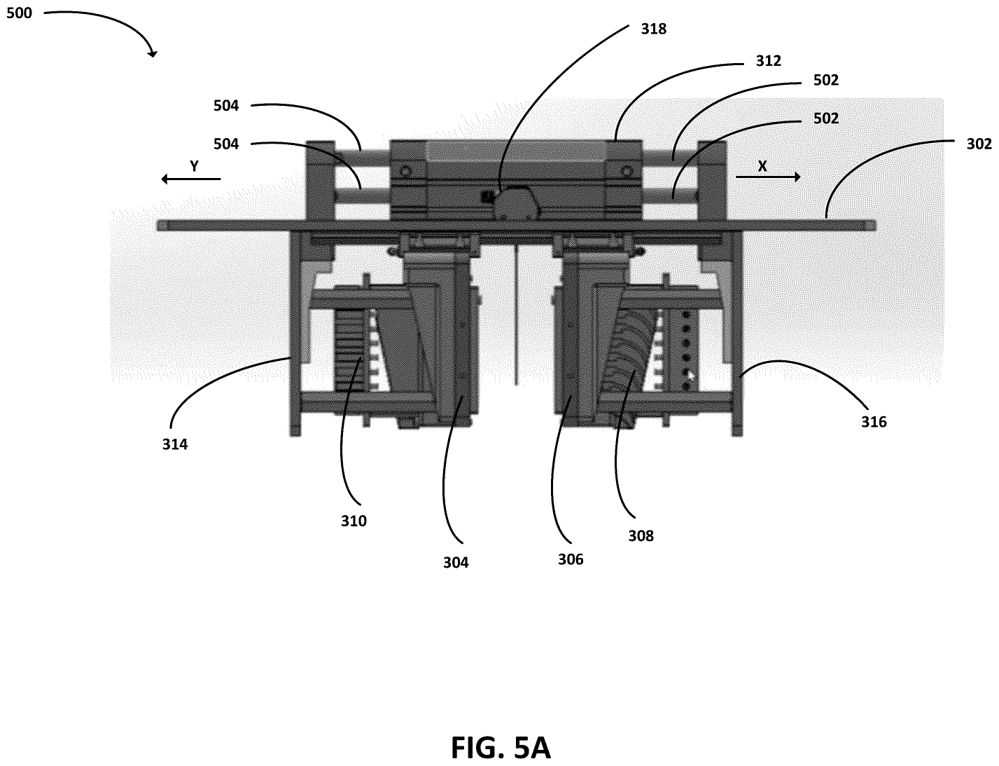

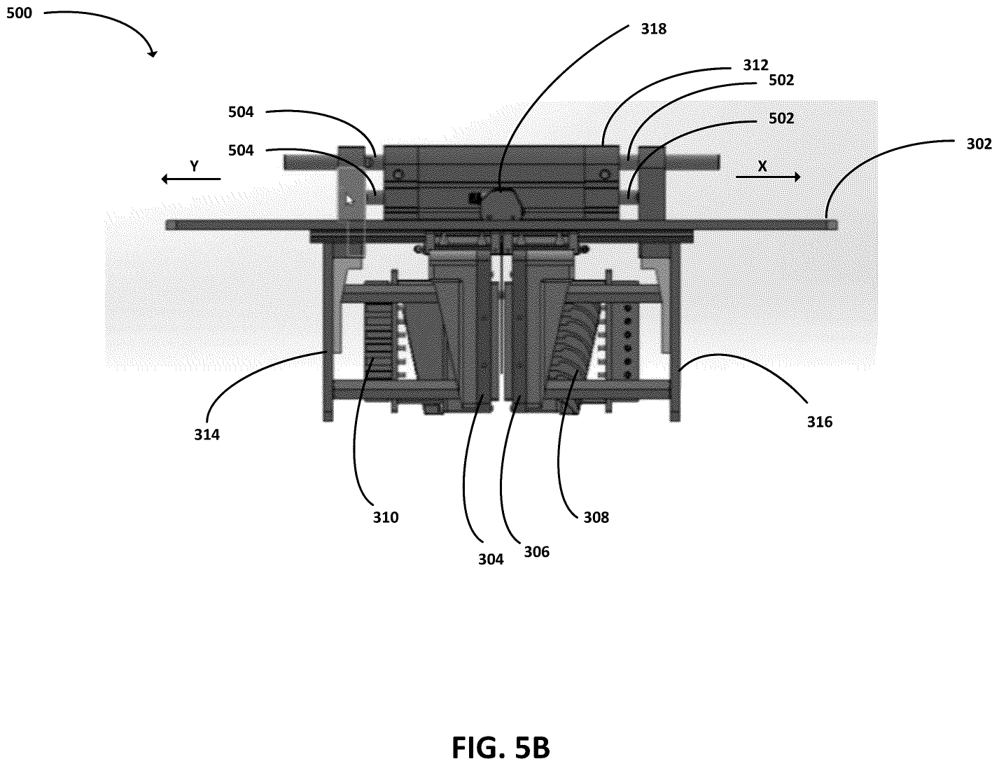

FIGS. 5A-B show two snapshots of holder 300 in open and closed positions respectively according to some aspects of the present disclosure.

Snapshot 500 shows the same holder as holder 400 in FIG. 4 where holder 400 is in an open position and sample 102 is removed. Actuator 312 may move shafts 502 and 504 in X and Y directions respectively, causing side structures 314 and 316 to move in the same directions as shafts 502 and 504, which in turn moves plates 304 and 306 away from one another for sample 102 to be removed.

FIG. 5B illustrates the same holder 400 as in FIG. 5A in a closed position (without sample 102 being inserted between plates 304 and 306).

In example embodiments described above, sample 102 can be any known or to be developed type of battery cell including, but not limited to, a prismatic cell, a pouch cell, and/or a cylindrical cell. It should be understood that the shape and design of example holder systems and various components thereof, as described above with reference to FIGS. 3-5B may be altered and modified to accommodate any particular type of battery cell to be acoustically measured. For example, the shape and hence movement of plates 304 and 306 may be adjusted when sample 102 is a cylindrical battery cell.

In one or more aspects of the present disclosure, one or more sensors such as sensors 318 may be placed as shown in FIGS. 3-5A-B as well as on actuator 312. Such sensors can be used to detect a position of a sample relative to plates 304 and 306 and provide feedback to actuator 312 about the same. Once the sample is in an ideal position (which may vary from sample to sample depending on factors such as size, shape, width, length, etc.), actuator 312 may synchronously move side structures 314 and 316 to close plates 304 and 306 and hence bring sensors 308 and 310 into contact with the sample in place. In another example and after determining the position of the sample, the position of the sample or plates would be adjusted to ensure symmetry in the sensor planes. For instance, the sample can be placed on an automated adjustment stage to position the sample equidistant from the ultrasonic sensors on each side. In other words, sensor(s) 318 may function as a feedback loop for determining when to close and/or open plates 304 and 306 for any given sample subject to ultrasound measurements.

Actuator 312 may be communicatively coupled to processor 110 (or may have an independent chip/processor installed thereon) that may provide signals and commands for actuating movement of sensors 308 and 310. If processor 110 is used for such purpose, then sensors 318 may be communicatively coupled to processor 110 for providing sample position information to processor 110 for purposes of determining when to actuate movement of sensors 308 and 310.

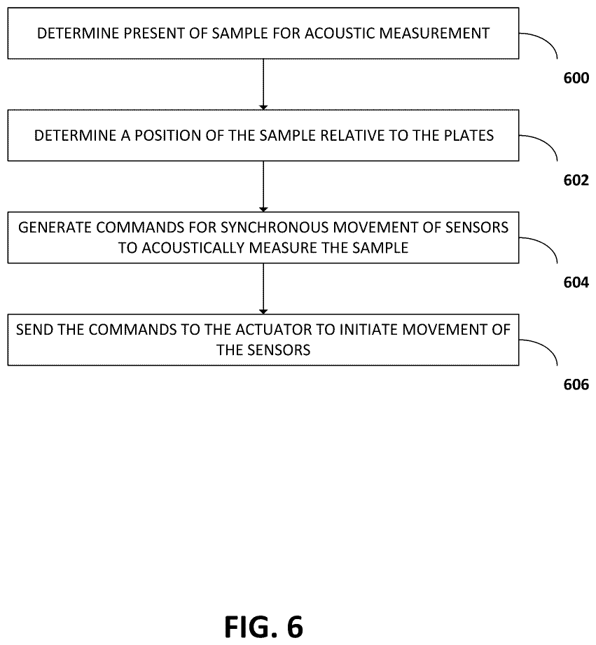

FIG. 6 is a flowchart of a method of operating actuator of FIGS. 3 through 5A-B according to some aspects of the present disclosure.

At step 600, processor 110 (which may be referred to as a controller) may determine (detect) that sample (e.g., sample 102) is present between plates 304 and 306 for acoustic measurements. This determination may be based on detection of sample 102 by one or more sensors such as sensor 318.

At step 602, processor 110 may determine a position (placement) of the sample present between plates 304 and 306, relative to plates 304 and 306. This determination may also be based on data sensed (collected) by sensor(s) 318 as to a position of the sample relative to plates 304 and 306.

At step 604 and based on determining that the sample is present and determining the position of the sample relative to plates 304 and 306, processor 110 generates commands for moving sensors 308 and 310 synchronously in order to bring sensors 308 and 310 into contact with the sample for performing acoustic measurement of the sample.

In one example, the commands may be such that while plates sensors 308 and 310 are moved simultaneously, the movement of each of sensors 308 and 310 may be at different speeds in order to ensure that sensors 308 and 310 come into contact with the sample at the same time. This difference in the speed with which sensors 308 and 310 move may be due to, for example, the sample being placed closer to plate 304 than plate 306 or vice-versa.

At step 606, processor 110 may send the commands generated at step 604 to actuator 312 such that actuator 312 can initiate movement of sensors 308 and 310.

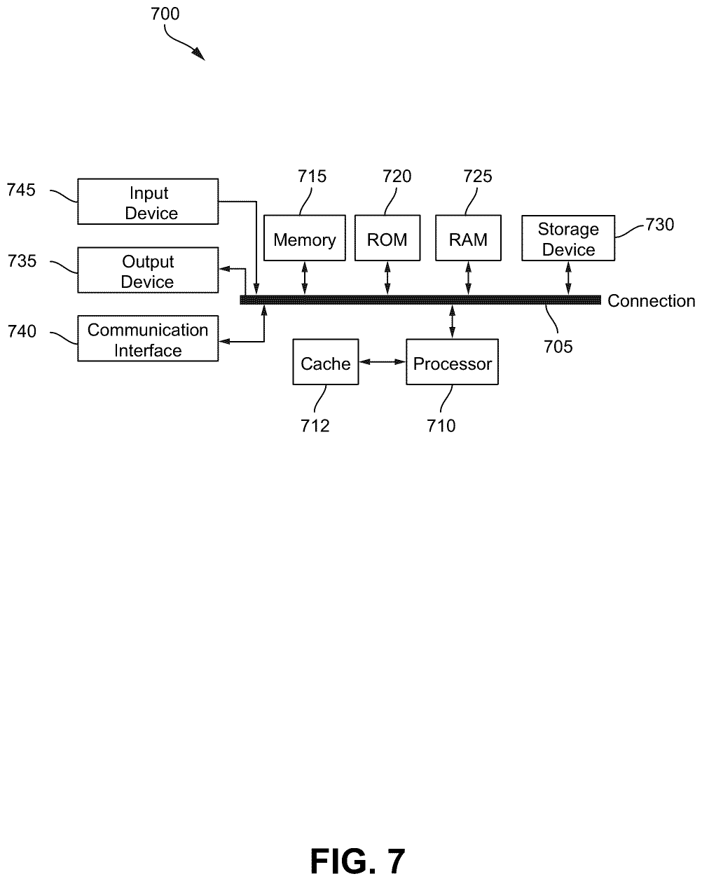

FIG. 7 illustrates an example computing device architecture of an example computing device, in accordance with some aspects of the disclosure. Device architecture 700 of an example computing device which can be used as various components of system 100 or 200 (e.g., processor 110) implement various techniques described herein. The components of the computing device architecture 700 are shown in electrical communication with each other using a connection 705, such as a bus. The example computing device architecture 700 includes a processing unit (CPU or processor) 710 and a computing device connection 705 that couples various computing device components including the computing device memory 715, such as read only memory (ROM) 720 and random access memory (RAM) 725, to the processor 710.

The computing device architecture 700 can include a cache of high-speed memory connected directly with, in close proximity to, or integrated as part of the processor 710. The computing device architecture 700 can copy data from the memory 715 and/or the storage device 730 to the cache 712 for quick access by the processor 710. In this way, the cache can provide a performance boost that avoids processor 710 delays while waiting for data. These and other modules can control or be configured to control the processor 710 to perform various actions. Other computing device memory 715 may be available for use as well. The memory 715 can include multiple different types of memory with different performance characteristics. The processor 710 can include any general-purpose processor and a hardware or software service stored in storage device 730 and configured to control the processor 710 as well as a special-purpose processor where software instructions are incorporated into the processor design. The processor 710 may be a self-contained system, containing multiple cores or processors, a bus, memory controller, cache, etc. A multi-core processor may be symmetric or asymmetric.

To enable user interaction with the computing device architecture 700, an input device 745 can represent any number of input mechanisms, such as a microphone for speech, a touch-sensitive screen for gesture or graphical input, keyboard, mouse, motion input, speech and so forth. An output device 735 can also be one or more of a number of output mechanisms known to those of skill in the art, such as a display, projector, television, speaker device. In some instances, multimodal computing devices can enable a user to provide multiple types of input to communicate with the computing device architecture 700. The communication interface 740 can generally govern and manage the user input and computing device output. There is no restriction on operating on any particular hardware arrangement and therefore the basic features here may easily be substituted for improved hardware or firmware arrangements as they are developed.

Storage device 730 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 725, read only memory (ROM) 720, and hybrids thereof. The storage device 730 can include software, code, firmware, etc., for controlling the processor 710. Other hardware or software modules are contemplated. The storage device 730 can be connected to the computing device connection 705. In one aspect, a hardware module that performs a particular function can include the software component stored in a computer-readable medium in connection with the necessary hardware components, such as the processor 710, connection 705, output device 735, and so forth, to carry out the function.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Accordingly, an aspect of the present disclosure can include a computer-readable media embodying a method of improvements to one or more processes in the manufacturing of battery cells using acoustic signal-based analysis. Accordingly, the present disclosure is not limited to illustrated examples and any means for performing the functionality described herein are included in aspects of the present disclosure.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the concepts presented herein may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and ≤ greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

While the foregoing disclosure shows illustrative aspects of the present disclosure, it should be noted that various changes and modifications could be made herein without departing from the scope of the present disclosure as defined by the appended claims. The functions, steps and/or actions of the method claims in accordance with the aspects of the present disclosure described herein need not be performed in any particular order. Furthermore, although elements of the present disclosure may be described or claimed in the singular, the plural is contemplated unless limitation to the singular is explicitly stated.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A system for performing acoustic measurements on battery cells, the system comprising:
a plurality of transmitting sensors configured to transmit acoustic signals across a sample;
a plurality of receiving sensors configured to receive response signals through the sample in response to the acoustic signals transmitted therethrough; and
an actuator configured to synchronously actuate the plurality of transmitting sensors and the plurality of receiving sensors to provide same spacing and speed of motion between the plurality of transmitting sensors and the plurality of receiving sensors relative to the sample.

2. The system of claim 1, further comprising:
at least one sensor configured to determine a placement of the sample relative to two plates in between which the sample is positioned for performing the acoustic measurements.

3. The system of claim 2, wherein the actuator is configured to adjust the speed of motion based on feedback received from the at least one sensor.

4. The system of claim 2, wherein the actuator is configured to synchronously actuate the plurality of transmitting sensors and the plurality of receiving sensors when the at least one sensor indicates the placement of the sample to be correct relative to the two plates.

5. The system of claim 4, wherein the placement of the sample relative to the two plates is correct when the sample is at an equidistance from the two plates.

6. The system of claim 1, further comprising:
a first side structure mechanically attached to the actuator and configured to control movement of the plurality of transmitting sensors; and
a second side structure mechanically attached to the actuator and configured to control movement of the plurality of receiving sensors.

7. The system of claim 1, further comprising:
a holder mechanically coupled to the actuator, the holder configured to hold in place the actuator for acoustic measurement of batteries.

8. The system of claim 1, wherein the sample is a pouch battery cell.

9. The system of claim 1, wherein the sample is a cylindrical battery cell.

10. The system of claim 1, wherein the sample is a prismatic battery cell.

11. A system comprising:
a controller including one or more memories having computer-readable instructions stored therein, and one or more processors configured to execute the computer-readable instructions to:
determine a location of a sample relative to a holder mechanism, wherein the holder mechanism is configured to hold the sample to be acoustically measured using a plurality of transmitting sensors and a plurality of receiving sensors; and
generate one or more commands for actuating synchronous movement of the plurality of transmitting sensors and the plurality of receiving sensors such that the plurality of transmitting sensors and the plurality of receiving sensors come into contact with the sample at a same time for acoustic measurement of the sample.

12. The system of claim 11, further comprising:
an actuator configured to receive the one or more commands for actuating the synchronous movement of the plurality of transmitting sensors and the plurality of receiving sensors.

13. The system of claim 11, further comprising:
one or more sensors configured to collect data on a position of the sample relative to one or more plates that are configured to hold the sample in place to be acoustically measured.

14. The system of claim 13, wherein the controller is configured to determine the location based on the data collected by the one or more sensors.

15. The system of claim 13, wherein the controller is configured to adjust a position of the sample based on the data collected by the one or more sensors such that the sample is at an equidistance relative to two plates configured to hold the sample to be acoustically measured using the plurality of transmitting sensors and the plurality of receiving sensors.

16. The system of claim 13, wherein the actuator is configured to adjust a speed of motion of the plurality of transmitting sensors and the plurality of receiving sensors based at least in part on the data collected by the one or more sensors.

17. The system of claim 12, further comprising:
a first side structure mechanically attached to the actuator and configured to control movement of the plurality of transmitting sensors; and
a second side structure mechanically attached to the actuator and configured to control movement of the plurality of receiving sensors.

18. The system of claim 11, wherein the sample is a pouch battery cell.

19. The system of claim 11, wherein the sample is a cylindrical battery cell.

20. The system of claim 11, wherein the sample is a prismatic battery cell.
